(19) United States
(12) Patent Application Publication
(10) Pub. No.: US 2024/0005558 A1
(43) Pub. Date: Jan. 4, 2024

(54) AUTOMOTIVE COLOR MATCHING SYSTEM AND METHOD

(71) Applicant: PPG Industries Ohio, Inc., Cleveland, OH (US)

(72) Inventors: Alison M. Norris, Gibsonia, PA (US); Nicholas Tullett, Strongville, OH (US); Matthew K. Lynch, Cleveland, OH (US)

(73) Assignee: PPG Industries Ohio, Inc., Cleveland, OH (US)

(21) Appl. No.: 18/251,722

(22) PCT Filed: Nov. 5, 2021
(86) PCT No.: PCT/US2021/058153

§ 371 Date: May 4, 2023

Related U.S. Application Data
(60) Provisional application No. 63/110,735, filed on Nov. 6, 2020.

(51) Int. Cl. G06T 7/90; G01J 3/46; G06T 7/00; G06V 30/10

(52) U.S. Cl. CPC G06T 7/90; G01J 3/463; G06T 2207/30156; G06V 30/10; G06T 7/0004

(57) ABSTRACT

A computer system for identifying coating colors using a digital image comprises one or more processors and one or more computer-readable media having store thereon executable instructions that when executed by the one or more processors configure the computer system to perform various actions. For example, the computer system can receive, through the network connection, a user-provided digital image of a vehicle. The computer system can also identify, with an image processing module, one or more vehicle characteristics within the user-provided digital image. Further, the computer system can identify at least one coating color based on the one or more vehicle characteristics.

### BACKGROUND

When a vehicle undergoes repair, a repair paint is applied to the vehicle, which should match the original paint. However, due to color shifts in the original paint applied to vehicles during manufacturing, it is difficult to match the repair paint to the original paint. Differences between the original vehicle paint and a repair paint on the vehicle can be perceived. The color variations of paint produced by original equipment manufacturers are difficult to color match in the multitude of auto body repair shops that repaint vehicles.

Vehicles typically include one or more identification tags, including a color code that refers to the original paint formulation. Auto body repair shop employees are conventionally required to hand-enter metadata associated with the vehicle in the repair shop in order to identify the color code that best matches the paint of a vehicle undergoing repair. The metadata includes vehicle make, model, year, color code, VIN, etc. However, hand-entry is prone to mistakes, cumbersome, time-consuming. Further, color codes are becoming more and more difficult to locate on vehicle bodies, making it labor-intensive for repair shop employees to find and enter color code data. Delays associated with refinish paint color matching in the repair process are costly to the auto body repair shop in terms of productivity and associated expenses.

Accordingly, there are many opportunities for new systems and methods that aid repair shops in their selection of a paint color.

### BRIEF SUMMARY

A computer system for identifying coating colors using a digital image comprises one or more processors and one or more computer-readable media having store thereon executable instructions that when executed by the one or more processors configure the computer system to perform various actions. For example, the computer system can receive, through the network connection, a user-provided digital image of a vehicle. The computer system can also access, within a vehicle template database, one or more vehicle templates. Further, the computer system can map at least one conforming vehicle template to the vehicle within the user-provided digital image, wherein the at least one conforming vehicle template comprises associated metadata comprising the one or more vehicle characteristics, including one or more associated color codes. The computer system can also identify, with an image processing module, a color value associated with the vehicle within the user-provided digital image. Finally, the computer system calculate a closest match for identified color value associated with the vehicle from the one or more associated color codes.

A computerized method for use with a computer system comprising one or more processors and one or more computer-readable media having stored thereon executable instructions that when executed by the one or more processors configure the computer system to perform a method of identifying coating colors using a digital image. The method can comprise receiving, through the network connection, a user-provided digital image of a vehicle. The method can also comprise accessing, within a vehicle template database, one or more vehicle templates. The method can further comprise mapping at least one conforming vehicle template to the vehicle within the user-provided digital image, wherein the at least one conforming vehicle template comprises associated metadata comprising the one or more vehicle characteristics, including one or more associated color codes. Also, the method can include identifying, with an image processing module, a color value associated with the vehicle within the user-provided digital image. The method can comprise calculating a closest match for identified color value associated with the vehicle from the one or more associated color codes. Finally, the method can comprise providing a user the calculated closest match.

A computer program product comprising one or more computer storage media having stored thereon computer-executable instructions that, when executed at a processor, cause the computer system to perform a method for identifying coating colors using a digital image. The method can comprise receiving, through a network connection, a user-provided digital image of a vehicle. The method can also include accessing, within a vehicle template database, one or more vehicle templates. The method can further comprise mapping at least one conforming vehicle template to the vehicle within the user-provided digital image, wherein the at least one conforming vehicle template comprises associated metadata comprising the one or more vehicle characteristics, including one or more associated color codes. Also, the method can include identifying, with an image processing module, a color value associated with the vehicle within the user-provided digital image. The method can comprise calculating a closest match for identified color value associated with the vehicle from the one or more associated color codes. Additionally, the method can include providing a user the calculated closest match. Further, the method can comprise receiving user feedback that the calculated closest match is incorrect, calculating a color shift profile, and applying the color shift profile to user-provided digital images of vehicles comprising camera and lighting characteristics of the user-provided digital image of the vehicle.

Additional features and advantages will be set forth in the description which follows, and in part will be obvious from the description, or may be learned by practice. The features and advantages may be realized and obtained by means of the instruments and combinations particularly pointed out in the appended claims. These and other features will become more fully apparent from the following description and appended claims, or may be learned by the practice of the examples as set forth hereinafter.

### BRIEF DESCRIPTION OF THE DRAWINGS

In order to describe the manner in which the above recited and other advantages and features can be obtained, a more particular description briefly described above will be rendered by reference to specific examples thereof, which are illustrated in the appended drawings. Understanding that these drawings are merely illustrative and are not therefore to be considered to be limiting of its scope, the computer system for dynamically parsing a digital image to identify coating colors will be described and explained with additional specificity and detail through the use of the accompanying drawings in which:

FIG. 1 depicts a schematic diagram of a network-based system for identifying coating colors using a digital image;

FIG. 2 depicts an exemplary user-provided digital image of a vehicle;

FIG. 3 depicts an exemplary vehicle template database comprising vehicle templates;

FIG. 4 depicts the exemplary user-provided digital image shown in FIG. 2, wherein a conforming vehicle template is mapped to the vehicle;

FIG. 5 depicts an exemplary repair template database comprising repair templates;

FIG. 6 depicts the exemplary user-provided digital image shown in FIG. 2, wherein a conforming repair template is mapped to the vehicle;

FIG. 7 depicts a modified user-provided digital image; and

FIG. 8 illustrates a flow chart of a series of acts in a method for identifying a coating color using a digital image.

### DETAILED DESCRIPTION

A computer system for identifying coating colors using a digital image comprises one or more processors and one or more computer-readable media having store thereon executable instructions that when executed by the one or more processors configure the computer system to perform various actions. For example, the computer system can receive, through the network connection, a user-provided digital image of a vehicle. The computer system can also access, within a vehicle template database, one or more vehicle templates. Further, the computer system can map at least one conforming vehicle template to the vehicle within the user-provided digital image, wherein the at least one conforming vehicle template comprises associated metadata comprising the one or more vehicle characteristics, including one or more associated color codes. As used herein, “vehicle characteristics” may also comprise a vehicle make, model, year, or vehicle identification number (VIN). The computer system can also identify, with an image processing module, a color value associated with the vehicle within the user-provided digital image. Finally, the computer system calculate a closest match for identified color value associated with the vehicle from the one or more associated color codes.

As such, the computer system can provide several benefits to the art. For example, the described coating color identification process may reduce the chance of human error when entering vehicle characteristics. The color identification process may also detect subtle color variances that are not detectable by the human eye. Further the described computer system may increase the speed at which auto body repair shops identify a refinish paint color thereby increasing their productivity.

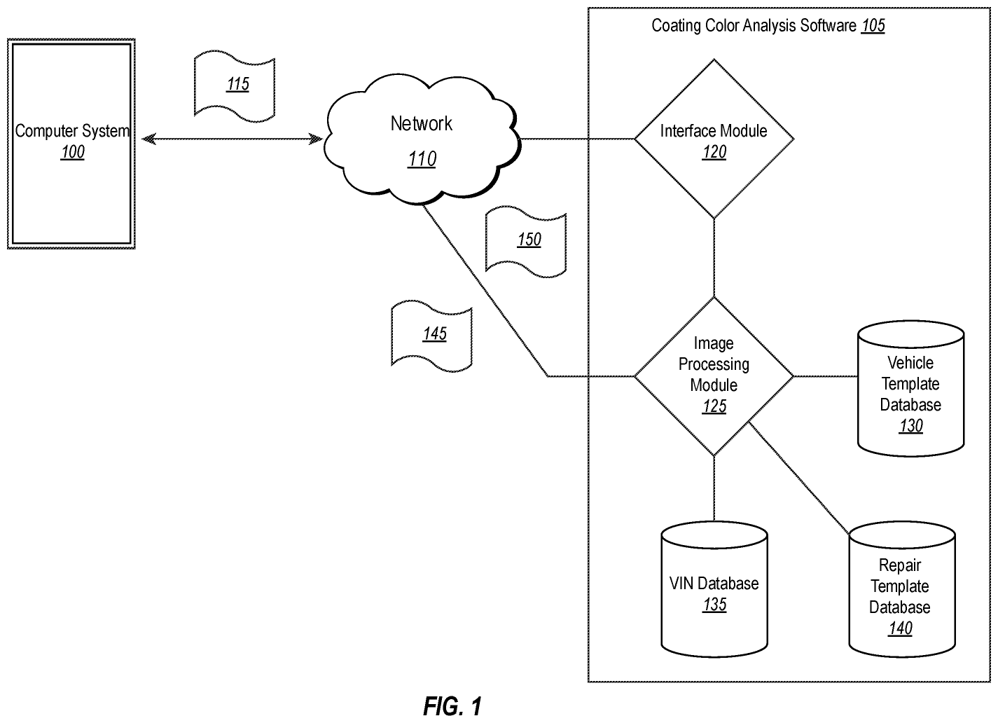

Turning now to the figures, FIG. 1 illustrates a schematic of a computerized system for identifying a coating color using a digital image. As shown, a computer system 100 is in communication with coating color analysis software 105 through a network connection 110. One skilled in the art will appreciate that the depicted schematic is merely exemplary, and although the computer system 100 is depicted in FIG. 1 as a mobile phone, the computer system 100 can take a variety of forms. For example, the computer system 100 may be a laptop computer, a tablet computer, a wearable device, a desktop computer, a mainframe, etc. As used herein, the term “computer system” includes any device, system, or combination thereof that includes one or more processors, and a physical and tangible computer-readable memory capable of having thereon computer-executable instructions that are executable by the one or more processors.

The one or more processors may comprise an integrated circuit, a field-programmable gate array (FPGA), a microcontroller, an analog circuit, or any other electronic circuit capable of processing input signals. The memory may be physical system memory, which may be volatile, non-volatile, or some combination of the two. The term “memory” may also be used herein to refer to non-volatile mass storage such as physical storage media. Examples of computer-readable physical storage media include RAM, ROM, EEPROM, solid state drives (“SSDs”), flash memory, phase-change memory (“PCM”), optical disk storage, magnetic disk storage or other magnetic storage devices, or any other hardware storage device(s). The computer system 100 may be distributed over a network environment and may include multiple constituent computer systems.

The computer system 100 can comprise one or more computer-readable storage media having stored thereon executable instructions that when executed by the one or more processors configure the computer system 100 to execute the coating color analysis software 105. The coating color analysis software 105 may comprise various modules, such as an interface module 120 and an image processing module 125. As used herein, a module may comprise a software component, including a software object, a hardware component, such as a discrete circuit, a FPGA, a computer processor, or some combination of hardware and software.

One will understand, however, that separating modules into discrete units is at least somewhat arbitrary and that modules can be combined, associated, or separated in ways other than shown in FIG. 1 and still accomplish the purposes of the computer system. Accordingly, the modules 120 and 125 of FIG. 1 are only shown for illustrative and exemplary purposes.

The coating color analysis software 105 may also be in communication with one or more databases. For example, the coating color analysis software 105 may be in communication with a vehicle template database 130, a vehicle identification number (“VIN”) database 135, and a repair template database 140. As used herein, a database may comprise locally stored data, remotely stored data, data stored within an organized data structure, data stored within a file system, or any other stored data that is accessible to the coating color analysis software 105.

The coating color analysis software 105 may be configured to receive a user-provided digital image of a vehicle 115. For example, the user may use the computer system 100 to upload a user-provided digital image 115 to the coating color analysis software 105 via the network connection 110. As used herein, a digital image may comprise a photograph (e.g., a still of a physical reality) or and an image either digitally representing reality or a digitally-created artifact. The interface module 120 may provide an interface for selecting a digital image available to the user and uploading the user-provided digital image 115 into the coating color analysis software 105. Additionally or alternatively, the interface module 120 may allow the user to provide additional or alternative vehicle-identifying data. For example, the interface module 120 may allow the user to type, speak, or otherwise identify details about the vehicle (e.g., make, model, color, etc.).

The interface module 120 may be configured to receive user-derived audio comprising vehicle characteristics and translate the user-derived audio to machine-encoded text. For example, the coating color analysis software 105 may be configured to receive user-derived audio from a voice recognition system installed on the computer system 100. Additionally or alternatively, the voice recognition system may translate the user-derived audio to machine-encoded text before sending the machine-encoded text to the coating color analysis software 105.

The user-provided digital image 115 may comprise a color or black/white photograph of the vehicle showing at least a portion of the body of the vehicle. The interface module 120 may provide an interface for identifying the angle at which the user-provided digital image 115 was taken. The interface module 120 may also provide an interface for uploading more than one image of the vehicle at multiple angles. The image processing module 125 may be configured to identify the observation angle of the user-provided digital image 115 without input from the user.

As shown in FIG. 1, the interface module 120 may be in communication with the image processing module 125 and configured to send the user-provided digital image 115 to the image processing module 125. The image processing module 125 may access, within the vehicle template database 130, one or more vehicle templates, and map a conforming vehicle template to the vehicle within the user-provided digital image 115. The conforming vehicle template may comprise associated metadata comprising the one or more vehicle characteristics, including one or more associated color codes.

A vehicle template may comprise a digital description of the physical, viewable characteristics of a particular vehicle. In some cases, the vehicle templates may comprise labelled data relating to vehicles that can be loaded into a neural network. A vehicle template may also be associated with metadata that describes various aspects of the underlying vehicle. The metadata may include vehicle characteristics such as model, make, body style, year range, color, and one or more associated color codes. After the conforming vehicle template is mapped to the vehicle within the user-provided digital image 115, the image processing module 125 may identify vehicle characteristics based on the metadata associated with the conforming vehicle template.

The vehicle templates may comprise line drawings of vehicles. The vehicle templates may also comprise three-dimensional models of vehicles. The image processing module 125, therefore, may map the conforming vehicle template to the vehicle in the user-provided digital image 115 by line matching. The image processing module 125 may also be configured to automatically adjust the size of the conforming vehicle template to align with the vehicle in the user-provided digital image 115. Therefore, a vehicle template may be conformed by matching various vehicle templates and choosing the vehicle template with the least differences (e.g., structural differences) through line matching.

The vehicle templates may also comprise a color element, and the image processing module 125 may be configured to determine the color of the vehicle in the user-provided digital image 115 and map a color-matched conforming vehicle template to the vehicle. Therefore, the color-matching of the conforming vehicle template additionally matches the determined color of the vehicle in the user-provided digital image 115 with color information of the vehicle template, wherein a color is matched if the quantitative difference in a specific color space such as “delta e (ΔE) is less than X”.

Additionally or alternatively, the image processing module 125 may comprise a machine learning algorithm that is configured to identify vehicle characteristics within the user-provided digital image 115. The machine learning algorithm may be taught using annotated vehicle templates stored within the vehicle template database 130. In some cases, the machine learning algorithm may also map the identified vehicle to vehicle templates within the vehicle template database 130. The machine learning algorithm may comprise any number of different object recognition and object classification algorithms, including a convolutional neural network. Information can then be gathered from the metadata associated with the vehicle template.

The vehicle template database 130 may include database subsets that are organized based on information provided by the user. For example, if the user indicated that the vehicle is a TOYOTA, the vehicle template database 130 may include a database subset with vehicle templates specific to TOYOTA vehicles. Additionally or alternatively, the image processing module 125 may first determine the color of the vehicle in the user-provided digital image 115 and the vehicle template database 130 may include a database subset with vehicle templates specific to the identified color. For example, a particular car model may come in eight different factory colors. The vehicle template database 130 may comprise vehicle templates that car model in each of the eight different factory colors.

Additionally, the image processing module 125 may identify a color value associated with the vehicle within the user-provided digital image 115. The color value associated with the vehicle may be an RGB value. Additionally or alternatively, the color value may be a color family (e.g., white, red, blue, silver). The image processing module may also calculate a closest match for identified color value associated with the vehicle from the one or more associated color codes. The closest match may be determined by comparing the quantitative differences in a specific color space such as “delta e (ΔE) is less than X”. The closest match may represent the most probable color code for the car.

As shown in FIG. 1, The image processing module 125 may be in communication with the computer system 100 through the network connection 110 and configured to send the computer system 100 the closest match 145. The Prime, Variants, and Specials for the closest match 145 may also be sent to the computer system 100. Additionally or alternatively, the interface module 120 may be configured to display the identified vehicle characteristics based on the metadata associated with the conforming vehicle template.

Additionally or alternatively, the image processing module may include a smart learning color verification process. For example, the interface module 120 or image processing module 125 may be configured to receive user feedback from the computer system 100 that the closest match color code is incorrect. The interface module 120 or image processing module 125 may be further configured to receive from the user an indication of the correct color code for the vehicle. Based on variance between the incorrect closest match color code and the user-identified color code, the image processing module may calculate a color shift profile. The image processing module 125 may apply the color shift profile to subsequent user-provided digital images comprising the camera and lighting characteristics of the user-provided digital image 115. The image processing module 125 may make alternative or additional modifications to a user-provided digital image before calculating a closest match 145.

Additionally or alternatively, the image processing module 125 may determine if the vehicle 115 has been repainted. For example, the image processing module 125 may be configured to identify when the closest match falls outside a predetermined threshold, such as “delta e (ΔE) is less than X”. If the closest match is identified as falling outside that threshold, the image processing module 125 may be configured to send the computer system 100 an indication that the vehicle was likely repainted. As discussed above, the image processing module 125 may be configured to send the computer system 100 confidence information based on the quantitative difference between the identified color value and color code.

The user-provided digital image 115 may additionally or alternatively comprise a photograph of image text associated with the vehicle. The image text may include the VIN, color code, make, model, and/or year of the vehicle. The image processing module 125 may be configured to identify image text within the user-provided digital image 115, and thereafter translate the identified image text to machine-encoded text using optical character recognition technology. If the image text comprises the VIN, the image processing module 125 may be in communication with the VIN database 135. The image processing module 125 may therefore use the machine-encoded text to search the VIN database 135 and identify vehicle characteristics. Alternatively, the vehicle template database 130 may comprise a VIN look-up table.

The VIN database 135 may comprise multiple look-up tables that correspond to specific letters or numbers in the VIN. For example, the VIN database may comprise a manufacturer look-up table. The image processing module 125 may use the second and third digits in the VIN to search the manufacturer look-up table and identify the manufacturer. Similarly, the VIN database may comprise a vehicle descriptor look-up table. The image processing module 125 may use the fourth through eighth digits of the VIN to search the vehicle descriptor look-up table and identify the brand, engine size, and type of vehicle. Additionally or alternatively, the image processing module may use a machine learning algorithm to identify vehicle characteristics based on the VIN. The machine learning algorithm may be taught using annotated VINs stored within the VIN database 135. The interface module 120 may be configured to display to the user the identified vehicle characteristics based on the VIN.

The VIN database may further comprise a color code look-up table. The image processing module 125 may use the identified vehicle characteristics to search within the color code look-up table and identify possible color codes based on the vehicle's make, model, year, etc. For example, the image processing module 125 may identify within the color code look-up table that nine possible color codes exist for a 2014 TOYOTA COROLLA. If no other information is known about the vehicle, the image processing module 125 may be configured to send all possible color codes to the computer system 100 through the network 110. If the user identifies the color of the vehicle, or the color of the vehicle is identified in the user-provided digital image 115, the image processing module 125 may filter the possible color codes before sending the color codes to the computer system 100. For example, if the user or image processing module 125 identifies that the 2014 TOYOTA COROLLA is white, the image processing module 125 may be configured to send white color codes (e.g. 070 for Blizzard/White Pearl Crystal and 040 for Super White) to the computer system color 100.

The image processing module 125 may also be configured to identify a repair area within the user-provided digital image 115. The image processing module 125 may detect a repair area by identifying where the mapped vehicle template differs from the vehicle. The image processing module 125 may access repair templates within a repair template database 140 and map a conforming repair template to the repair area within the user-provided digital image 115. The repair template database 140 may be organized into database subsets based on vehicle characteristics or repair area characteristics.

The repair templates may comprise a digital description of the physical, viewable characteristics of a particular repair. As with the vehicle templates, repair templates may comprise labelled data relating to repairs that can be loaded into a neural network. The repair templates may also be associated with metadata that describes various aspects of the underlying repair. The metadata may include detailed instructions concerning the repair, the estimated cost of the repair, and the estimated paint usage requirement for the repair.

The repair templates may comprise line drawings of vehicles. The image processing module 125, therefore, may map the conforming repair template to the repair area in the user-provided digital image 115 by line matching. The image processing module 125 may also be configured to automatically adjust the size or angle of the conforming repair template to align with the repair area in the user-provided digital image 115.

Additionally or alternatively, the image processing module 125 may comprise a machine learning algorithm that is configured to identify repair areas within the user-provided digital image 115. The machine learning algorithm may be taught using annotated repair templates stored within the repair template database 140. In some cases, the machine learning algorithm may also map the identified repair area to repair templates within the repair template database 130. The machine learning algorithm may comprise any number of different object recognition and object classification algorithms, including a convolutional neural network. Information can then be gathered from the metadata associated with the repair template.

After a conforming repair template is mapped to the repair area within the user-provided digital image 115, the image processing module 125 may identify repair characteristics 150 based on the metadata associated with the conforming repair template. The image processing module 125 may be in communication with the computer system 100 through the network connection 110 and configured to send the computer system 100 the identified repair characteristics 150. Additionally or alternatively, the interface module 120 may be configured to display the identified repair characteristics 150 based on the metadata associated with the conforming repair template.

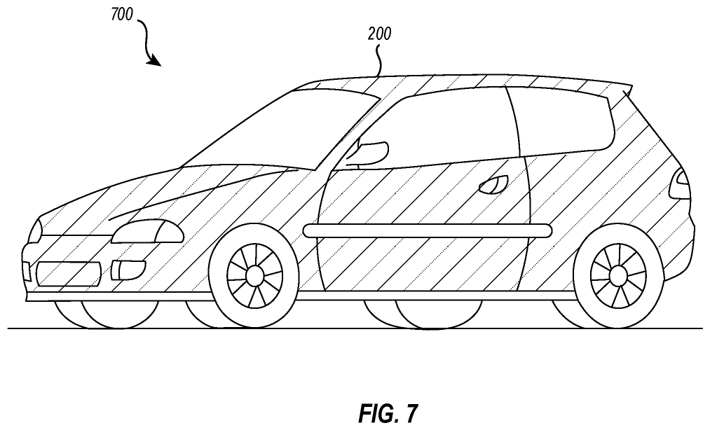

Additionally, the image processing module 125 may parse the repair area from the user-provided digital image 115 and create a modified user-provided digital image 700 (not shown, see FIG. 7) by replacing the parsed at least one repair area with visual data from the conforming vehicle template. The image processing module 125 may be configured to send the modified user-provided digital image to the computer system 100 through the network 110. Additionally or alternatively, the interface module 120 may be configured to show the user the modified user-provided digital image 700 (not shown, see FIG. 7).

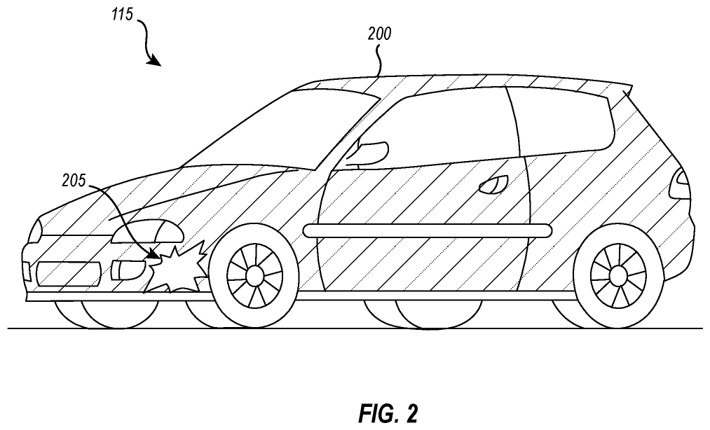

FIG. 2 depicts an exemplary user-provided digital image 115. The angle of the user-provided digital image 115 shown in FIG. 2 is merely exemplary. The user-provided digital image 115 may be taken from any angle. The user-provided digital image 115 includes a vehicle 200 and a repair area 205.

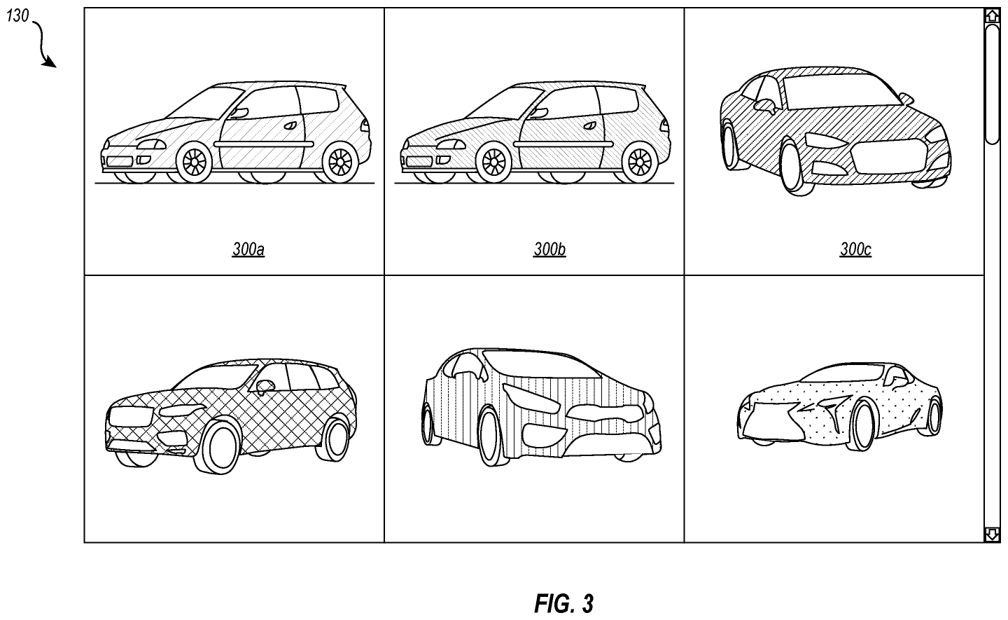

FIG. 3 depicts a portion of an exemplary vehicle template database 130 comprising vehicle templates 300a-300c. As shown, the vehicle template database 130 includes a vehicle template 300a that corresponds to the color and shape of the vehicle 200 shown in FIG. 1. The vehicle template database 130 also includes a vehicle template 300b that comprises the same shape of the vehicle 200 in FIG. 1 but is not the same color. A vehicle template 300c that has neither the corresponding color nor shape as the vehicle 200 shown in FIG. 2. Additionally or alternatively, the vehicle template database 130 may be organized in vehicle template database subsets based on vehicle characteristics.

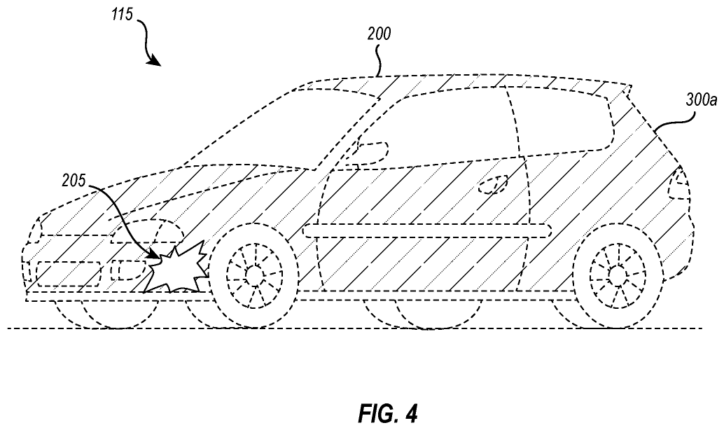

FIG. 4 shows the user-provided digital image 115 wherein the conforming vehicle template 300a has been mapped to the vehicle 200. As described above, the image processing module 125 may map the conforming vehicle template 300a by line matching and/or color matching. The image processing module 125 may also be configured to adjust the size of the conforming vehicle template 300a to align with the vehicle 200.

The conforming vehicle template 300a may be associated with metadata that describes various aspects of the underlying vehicle 200. The metadata may include vehicle characteristics such as model, make, body style, year range, color, and at least one color code. As stated above, the image processing module 125 may be in communication with the computer system 100 through the network connection 110 and configured to send the computer system 100 at least one identified closest match 145. Additionally or alternatively, the interface module 120 may be configured to display the identified vehicle characteristics based on the metadata associated with the conforming vehicle template 300a.

As shown in FIG. 4, the repair area 205 is unmapped, as the conforming vehicle template 300a does not include the same repair area. The image processing module 125 may be configured to detect the repair area 205 by identifying where the mapped conforming vehicle template 300a differs from the vehicle 200. For instance, the depicted repair area 205 may comprise a dent in the front, driver's side fender. The vehicle template 300a will not comprise an equivalent dent. As such, the vehicle template 300a can be digitally overlaid onto the user-provided digital image 115. A difference calculation can then be performed to identify that the front, driver's side fender (i.e., the repair area) differs from the vehicle template by a predetermined threshold. The predetermined threshold may comprise a volume amount, a color amount, a line matching deviation, or a number of other measurements of difference.

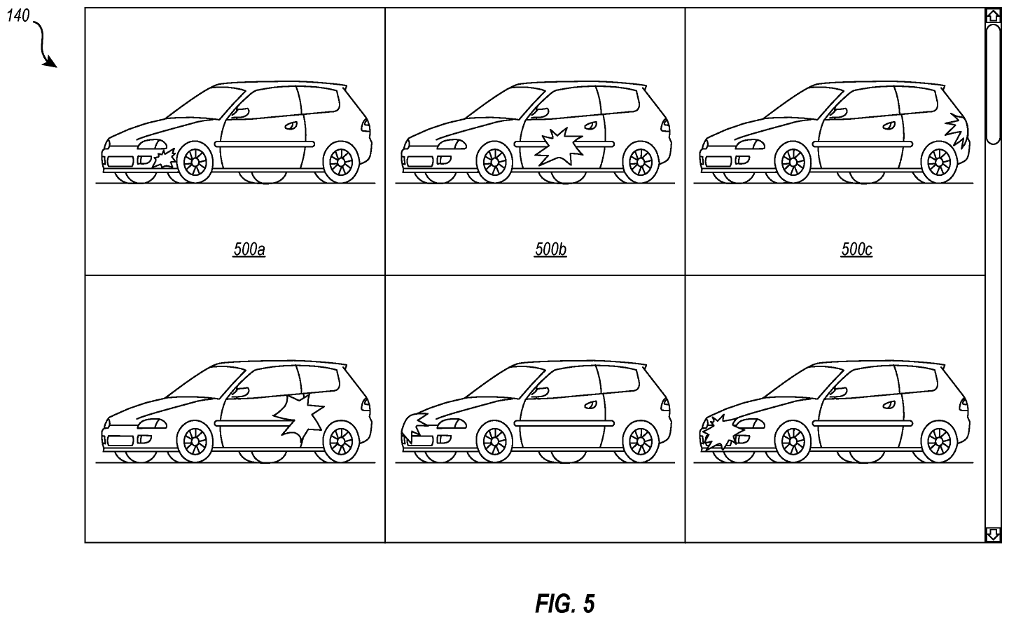

Upon identifying the existence of a difference at the front, driver's side fender, the image processing module 125 may access, within a repair template database 150, repair templates, as shown in FIG. 5. FIG. 5 a depicts a portion of an exemplary repair template database subset within a repair template database 150 comprising repair templates 500a-500c that are specific to the vehicle 200. A repair template 500a comprises the same repair area as the repair area 205 in the user-provided digital image 115. Additionally or alternatively, the repair template database subset may comprise repair templates specific to an area of a vehicle (e.g., right, front bumper).

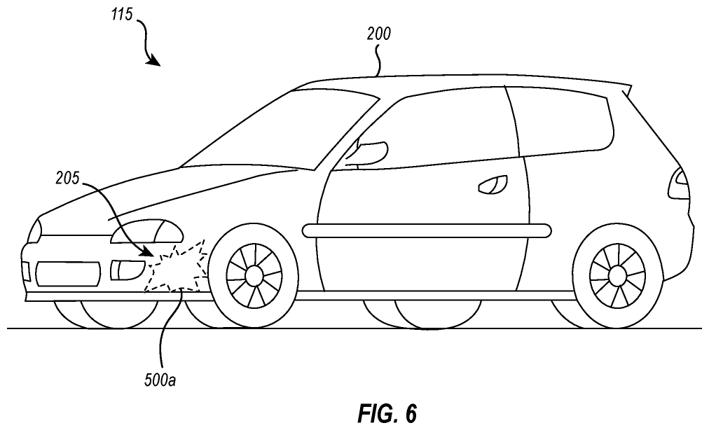

FIG. 6 shows a user-provided digital image 115 wherein the conforming repair template 500a has been mapped to the repair area 205. As described above, the image processing module 125 may map the conforming repair template 500a by minimizing the difference between a subset of the available repair templates. For instance, multiple repair templates may exist that comprise damage to the front, driver's side fender. The image processing module 125 may compare each of the templates associated with damage to the front, driver's side fender to the user-provided digital image 115 until a closest match is identified. The closest match may be identified through by minimizing the difference in volume between the template and the user-provided digital image, by minimizing the differences between line matching, or by minimizing any number of other measurements of difference. The image processing module 125 may also be configured to adjust the size or angle of the conforming repair template 500a to align with the repair area 205.

The conforming repair template 500a may be associated with metadata that describes various aspects of the underlying repair. The metadata may include detailed instructions concerning the repair, the estimated cost of the repair, and the estimated paint usage requirement for the repair. After a conforming repair template 500a is mapped to the repair area 205, the image processing module 125 may identify repair characteristics based on the metadata associated with the conforming repair template 500a. The image processing module 125 may be in communication with the computer system 100 through the network connection 110 and configured to send the computer system 100 the identified repair characteristics.

For example, in one case, a lightly damaged front, driver's side fender is mapped to a conforming repair template 500a that is associated with particularly the same, light damage. That conforming repair template 500a is associated with metadata indicating the automotive body filler and paint can be used to repair the damage. The metadata may further indicate an expected cost associated with the minor repair. In contrast, in another case, a heavily damaged front, driver's side fender is mapped to a conforming repair template 500a that is associated with particularly the same heavy damage. That conforming repair template 500a is associated with metadata indicating that the entire front, driver's side fender panel must be replaced and painted to match the rest of the vehicle. The metadata may indicate a relatively higher expected cost associated with the major repair.

One will appreciate that the above example is provided for clarity and simplicity. The same methods and systems can be applied to damage on other areas of a vehicle. Further, the same methods and systems can be applied to damage to multiple areas of the vehicle. For instance, a vehicle may have damage to the front, driver's side fender, the hood, and the driver's side door panel. In such a case, a repair template that has damage to these same repair areas 205 may be mapped to the digital image of the car. Similarly, multiple different repair templates can each be mapped to different respective areas of the car. For instance, a first repair template can be mapped to the front, driver's side fender, a second repair template can be mapped to the hood, and a third repair template can be mapped to the driver's side door panel. The metadata associated with each template can then be aggregated to identify a potential cost and parts associated with the repair.

FIG. 7 shows a modified user-provided digital image 700 wherein the repair area is parsed from the user-provided digital image 115 and replaced with visual data from the conforming vehicle template. As shown in FIG. 7, the modified user-provided digital image 700 comprises the vehicle 200 but does not include the repair area 205. The image processing module 125 may be configured to send the modified user-provided digital image 700 to the computer system 100 through the network 110. Additionally or alternatively, the interface module 120 may be configured to display the modified user-provided digital image 700.

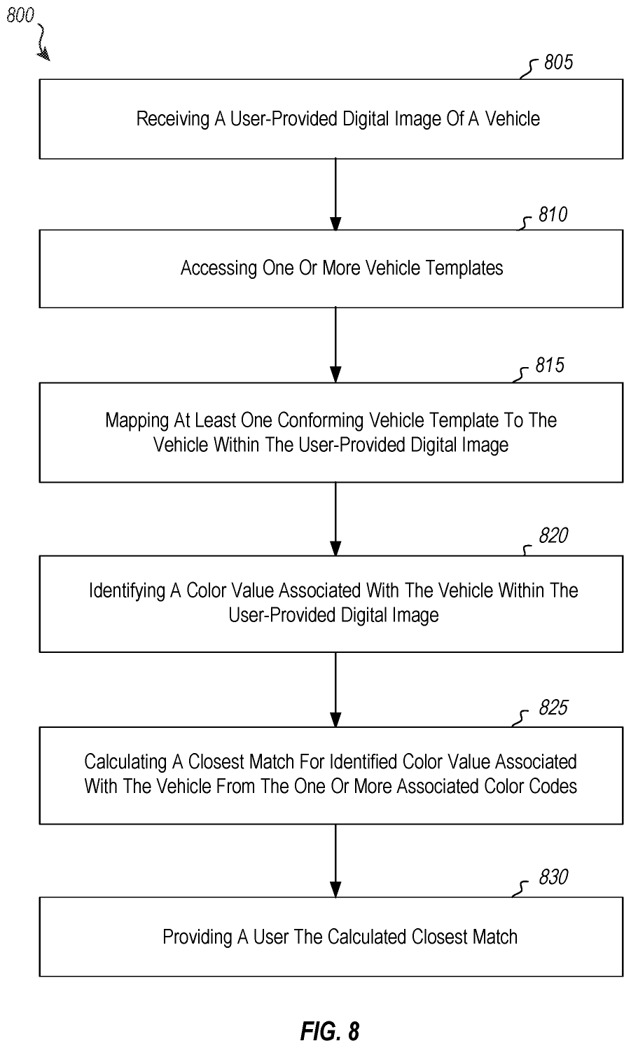

FIG. 8 illustrates a method 800 for identifying coating colors using a digital image. As shown in FIG. 8, act 805 comprises receiving a user-provided digital image of a vehicle. Act 805 includes receiving, through the network connection, a user-provided digital image of a vehicle. For example, as depicted in FIG. 1, the user may use the computer system 100 to upload a user-provided digital image 115 to the coating color analysis software 105 via the network connection 110. The interface module 120 may provide an interface for selecting a digital image available to the user and uploading the user-provided digital image 115 into the coating color analysis software 105. Additionally or alternatively, the interface module 120 may allow the user to type, speak, or otherwise identify details about the vehicle (e.g., make, model, color, etc.).

The user-provided digital image 115 may comprise a color photograph of the vehicle showing at least a portion of the body of the vehicle. The interface module 120 may provide an interface for identifying the angle at which the user-provided digital image 115 was taken. The interface module 120 may also provide an interface for uploading more than one image of the vehicle at multiple angles. The image processing module 125 may be configured to identify the observation angle of the user-provided digital image 115 without input from the user.

Further, as shown in FIG. 8, act 810 comprises accessing one or more vehicle templates. Act 805 includes accessing, within a vehicle template database, one or more vehicle templates. For example, as shown in FIG. 1, the image processing module 125 may access the vehicle template database 130.

FIG. 8 further shows that act 815 comprises mapping at least one conforming vehicle template to the vehicle within the user-provided digital image. Act 815 includes mapping at least one conforming vehicle template to the vehicle within the user-provided digital image, wherein the at least one conforming vehicle template comprises associated metadata comprising the one or more vehicle characteristics, including one or more associated color codes.

For example, as depicted in FIG. 4, the image processing module 125 may map a conforming vehicle template 300a to the vehicle 200 within the user-provided digital image 115. A vehicle template may comprise a digital description of the physical, viewable characteristics of a particular vehicle. In some cases, the vehicle templates may comprise labelled data relating to vehicles that can be loaded into a neural network. A vehicle template may also be associated with metadata that describes various aspects of the underlying vehicle. The metadata may include vehicle characteristics such as model, make, body style, year range, color, and one or more associated color codes. After the conforming vehicle template is mapped to the vehicle within the user-provided digital image 115, the image processing module 125 may identify vehicle characteristics based on the metadata associated with the conforming vehicle template.

The vehicle templates may comprise line drawings of vehicles. The vehicle templates may also comprise three-dimensional models of vehicles. The image processing module 125, therefore, may map the conforming vehicle template to the vehicle in the user-provided digital image 115 by line matching. The image processing module 125 may also be configured to automatically adjust the size of the conforming vehicle template to align with the vehicle in the user-provided digital image 115. Therefore, a vehicle template may be conformed by matching various vehicle templates and choosing the vehicle template with the least differences (e.g., structural differences) through line matching.

The vehicle templates may also comprise a color element, and the image processing module 125 may be configured to determine the color of the vehicle in the user-provided digital image 115 and map a color-matched conforming vehicle template to the vehicle. Therefore, the color-matching of the conforming vehicle template additionally matches the determined color of the vehicle in the user-provided digital image 115 with color information of the vehicle template, wherein a color is matched if the quantitative difference in a specific color space such as “delta e (ΔE) is less than X”.

Further, act 820 comprises identifying a color value associated with the vehicle within the user-provided digital image. Act 820 includes identifying, with an image processing module, a color value associated with the vehicle within the user-provided digital image. For example, the color value associated with the vehicle may be an RGB value.

As shown in FIG. 8, act 825 comprises calculating a closest match for identified color value associated with the vehicle from the one or more associated color codes. For example, the closest match may be determined by comparing the quantitative differences in a specific color space such as “delta e (ΔE) is less than X”.

Finally, act 830 comprises providing a user the calculated closest match. For example, as shown in FIG. 1, image processing module 125 may be in communication with the computer system 100 through the network connection 110 and configured to send the computer system 100 the closest match 145. Additionally or alternatively, the interface module 120 may be configured to display the identified vehicle characteristics based on the metadata associated with the conforming vehicle template.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The computer system may comprise or utilize a special-purpose or general-purpose computer system that includes computer hardware, such as, for example, one or more processors and system memory, as discussed in greater detail below. The computer system can also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the computer system can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the computer system.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the computer system may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The computer system may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the computer system may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment may comprise a system that includes one or more hosts that are each capable of running one or more virtual machines. During operation, virtual machines emulate an operational computing system, supporting an operating system and perhaps one or more other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

In view of the foregoing the present computer system relates for example, without being limited thereto, to the following aspects and configurations.

For example, in a first aspect, a computer system for identifying coating colors using a digital image can include one or more processors; and one or more computer-readable media having stored thereon executable instructions that when executed by the one or more processors configure the computer system to perform at least the following, as in particular performing the computerized method according to any of the thirteenth through twenty first aspects: receive, through a network connection, a user-provided digital image of a vehicle; access, within a vehicle template database, one or more vehicle templates; map at least one conforming vehicle template to the vehicle within the user-provided digital image, wherein the at least one conforming vehicle template comprises associated metadata comprising the one or more vehicle characteristics, including one or more associated color codes; identify, with an image processing module, a color value associated with the vehicle within the user-provided digital image; and calculate a closest match for identified color value associated with the vehicle from the one or more associated color codes.

In a second aspect, in the computer system of the first aspect, the color value associated with the vehicle is an RGB value. In a third aspect, in the computer system of any of the first or second aspects, the image processing module is configured to determine the color of the vehicle in the user-provided digital image and map a color-matched conforming vehicle template to the vehicle, wherein the at least one color-matched conforming vehicle template comprises associated metadata comprising the one or more vehicle characteristics. In a fourth aspect, in the computer system of any of the first through third aspects, the executable instructions include instructions that are executable to configure the computer system to provide a user the associated metadata comprising the one or more vehicle characteristics. In a fifth aspect, in the computer system of any of the first through fourth aspects, the executable instructions include instructions that are executable to configure the computer system to: receive user feedback that the closest match is incorrect; calculate a color shift profile; and apply the color shift profile to user-provided digital images of vehicles comprising camera and lighting characteristics of the user-provided digital image of the vehicle.

In a sixth aspect, in the computer system of any of the first through fifth aspects, the executable instructions include instructions that are executable to configure the computer system to: identify that the closest match falls outside a predetermined threshold; providing a user an indication that the vehicle was likely repainted. In a seventh aspect, in the computer system of any of the first through sixth aspects, the executable instructions include instructions that are executable to configure the computer system to identify at least one repair area within the user-provided digital image. In an eighth aspect, in the computer system of the seventh aspect, the step of identifying at least one repair area within the user-provided digital image comprises: detecting the at least one repair area where the mapped at least one conforming vehicle template differs from the vehicle; accessing, within a repair template database, one or more repair templates; and mapping at least one conforming repair template to the at least one repair area within the user-provided digital image.

In a ninth aspect, in the computer system of the seventh through eighth aspects, the executable instructions include instructions that are executable to configure the computer system to: parse the at least one repair area from the user-provided digital image; and create a modified user-provided digital image by replacing the parsed at least one repair area with visual data from the at least one conforming vehicle template. In a tenth aspect, in the computer system of any of the first through ninth aspects, the executable instructions include instructions that are executable to configure the computer system to identify image text within the user-provided digital image. In an eleventh aspect, in the computer system of any of the first through tenth aspects, the image processing module can include a machine learning algorithm. In a twelfth aspect, in the computer system of any of the first through eleventh aspects, the executable instructions include instructions that are executable to configure the computer system to: receive through the network connection, user-derived audio comprising one or more vehicle characteristics; and translate the user-derived audio to machine-encoded text.

In another configuration of the present invention, a computerized method for use on a computer system including one or more processors and one or more computer-readable media having stored thereon executable instructions that when executed by the one or more processors configure the computer system to perform a method of identifying coating colors using a digital image, for instance on a computer system as defined in the first through twelfth aspects, the method can include: receiving, through the network connection, a user-provided digital image of a vehicle; accessing, within a vehicle template database, one or more vehicle templates; mapping at least one conforming vehicle template to the vehicle within the user-provided digital image, wherein the at least one conforming vehicle template can include associated metadata comprising the one or more vehicle characteristics, including one or more associated color codes; identifying, with an image processing module, a color value associated with the vehicle within the user-provided digital image, wherein the color value is an RGB value; calculating a closest match for identified color value associated with the vehicle from the one or more associated color codes; and providing a user the calculated closest match.

In a fourteenth aspect, in the computerized method of the thirteenth aspect, the image processing module is configured to determine the color of the vehicle in the user-provided digital image and map a color-matched conforming vehicle template to the vehicle, wherein the at least one color-matched conforming vehicle template can include associated metadata comprising the one or more vehicle characteristics. In a fifteenth aspect, in the computerized method of any of the thirteenth to fourteenth aspects, the method can further include providing a user the associated metadata comprising the one or more vehicle characteristics. In a sixteenth aspect, the computerized method of any of the thirteenth through fourteenth aspects can further include receiving user feedback that the calculated closest match is incorrect; calculating a color shift profile; and applying the color shift profile to user-provided digital images of vehicles comprising camera and lighting characteristics of the user-provided digital image of the vehicle. In a seventeenth aspect, the computerized method of any of the thirteenth through sixteenth aspects can further include identifying that the closest match falls outside a predetermined threshold; and providing the user an indication that the vehicle was likely repainted.

In an eighteenth aspect, the computerized method of any of the thirteenth through seventeenth aspect can further include identifying at least one repair area within the user-provided digital image. In the computerized method of the eighteenth aspect, the step of identifying at least one repair area within the user-provided digital image can include detecting the at least one repair area where the mapped at least one conforming vehicle template differs from the vehicle; accessing, within a repair template database, a database subset of one or more repair templates; and mapping at least one conforming repair template to the at least one repair area within the user-provided digital image. In a twentieth aspect, the computerized method of any of the thirteenth through nineteenth aspects, the executable instructions include instructions that are executable to configure the computer system to: parse the at least one repair area from the user-provided digital image; and create a modified user-provided digital image by replacing the parsed at least one repair area with visual data from the at least one conforming vehicle template.

In a twenty-first aspect, in the computerized method of any of the thirteenth to twentieth aspects, the step of identifying, with the image processing module, the one or more vehicle characteristics within the user-provided digital image can include: identifying image text within the user-provided digital image; and translating the identified image text to machine-encoded text using optical character recognition technology.

In another configuration, a twenty-second aspect of the invention can include a computer program product that includes one or more computer storage media having stored thereon computer-executable instructions that, when executed at a processor, cause a computer system to perform a method for identify coating colors using a digital image, as in particular performing the computerized method according to any of the thirteenth through twenty-first aspects, for instance on a computer system as defines in the first to twelfth aspects, the method can include receiving, through a network connection, a user-provided digital image of a vehicle; accessing, within a vehicle template database, one or more vehicle templates; mapping at least one conforming vehicle template to the vehicle within the user-provided digital image, wherein the at least one conforming vehicle template can include associated metadata comprising the one or more vehicle characteristics, including one or more associated color codes; identifying, with an image processing module, a color value associated with the vehicle within the user-provided digital image; calculating a closest match for identified color value associated with the vehicle from the one or more associated color codes; providing a user the calculated closest match; receiving user feedback that the calculated closest match is incorrect; calculating a color shift profile; and applying the color shift profile to user-provided digital images of vehicles comprising camera and lighting characteristics of the user-provided digital image of the vehicle.

1. A computer system for identifying coating colors using a digital image, comprising:
one or more processors; and
one or more computer-readable media having stored thereon executable instructions that when executed by the one or more processors configure the computer system to perform at least the following:
receive, through a network connection, a user-provided digital image of a vehicle;
access, within a vehicle template database, one or more vehicle templates;
map at least one conforming vehicle template to the vehicle within the user-provided digital image,
wherein the at least one conforming vehicle template comprises associated metadata comprising the one or more vehicle characteristics, including one or more associated color codes;
identify, with an image processing module, a color value associated with the vehicle within the user-provided digital image; and
calculate a closest match for identified color value associated with the vehicle from the one or more associated color codes.

2. The computer system of claim 1, wherein the color value associated with the vehicle is an RGB value.

3. (canceled)

4. The computer system of claim 1, wherein the executable instructions include instructions that are executable to configure the computer system to provide a user the associated metadata comprising the one or more vehicle characteristics.

5. The computer system of claim 1, wherein the executable instructions include instructions that are executable to configure the computer system to:
receive user feedback that the closest match is incorrect;
calculate a color shift profile; and
apply the color shift profile to user-provided digital images of vehicles comprising camera and lighting characteristics of the user-provided digital image of the vehicle.

6. The computer system of claim 1, wherein the executable instructions include instructions that are executable to configure the computer system to:
identify that the closest match falls outside a predetermined threshold; and
provide a user an indication that the vehicle was likely repainted.

7. The computer system of claim 1, wherein the executable instructions include instructions that are executable to configure the computer system to identify at least one repair area within the user-provided digital image.

8. The computer system of claim 7, wherein identifying at least one repair area within the user-provided digital image comprises:
detecting the at least one repair area where the mapped at least one conforming vehicle template differs from the vehicle;
accessing, within a repair template database, one or more repair templates; and
mapping at least one conforming repair template to the at least one repair area within the user-provided digital image.

9. The computer system of claim 7, wherein the executable instructions include instructions that are executable to configure the computer system to:
parse the at least one repair area from the user-provided digital image; and
create a modified user-provided digital image by replacing the parsed at least one repair area with visual data from the at least one conforming vehicle template.

10. The computer system of claim 1, wherein the executable instructions include instructions that are executable to configure the computer system to identify image text within the user-provided digital image.

11. The computer system of claim 1, wherein the image processing module comprises a machine learning algorithm.

12. The computer system of claim 1, wherein the executable instructions include instructions that are executable to configure the computer system to:
receive through the network connection, user-derived audio comprising one or more vehicle characteristics; and
translate the user-derived audio to machine-encoded text.

13. A computerized method for use on a computer system comprising one or more processors and one or more computer-readable media having stored thereon executable instructions that when executed by the one or more processors configure the computer system to perform a method of identifying coating colors using a digital image, the method comprising:
receiving, through the network connection, a user-provided digital image of a vehicle;
accessing, within a vehicle template database, one or more vehicle templates;
mapping at least one conforming vehicle template to the vehicle within the user-provided digital image,
wherein the at least one conforming vehicle template comprises associated metadata comprising the one or more vehicle characteristics, including one or more associated color codes;
identifying, with an image processing module, a color value associated with the vehicle within the user-provided digital image;
calculating a closest match for identified color value associated with the vehicle from the one or more associated color codes; and
providing a user the calculated closest match.

14. (canceled)

15. The computerized method of claim 13, further comprising providing a user the associated metadata comprising the one or more vehicle characteristics.

16. The computerized method of claim 13, further comprising:
receiving user feedback that the calculated closest match is incorrect;
calculating a color shift profile; and
applying the color shift profile to user-provided digital images of vehicles comprising camera and lighting characteristics of the user-provided digital image of the vehicle.

17. The computerized method of claim 13, further comprising:
identifying that the closest match falls outside a predetermined threshold; and
providing the user an indication that the vehicle was likely repainted.

18. The computerized method of claim 13, further comprising identifying at least one repair area within the user-provided digital image.

19. The computerized method of claim 18, wherein identifying at least one repair area within the user-provided digital image comprises:
detecting the at least one repair area where the mapped at least one conforming vehicle template differs from the vehicle;
accessing, within a repair template database, a database subset of one or more repair templates; and
mapping at least one conforming repair template to the at least one repair area within the user-provided digital image.

20. The computerized method of claim 13, wherein the executable instructions include instructions that are executable to configure the computer system to:
parse the at least one repair area from the user-provided digital image; and
create a modified user-provided digital image by replacing the parsed at least one repair area with visual data from the at least one conforming vehicle template.

21. The computerized method of claim 13, wherein identifying, with the image processing module, the one or more vehicle characteristics within the user-provided digital image comprises:
identifying image text within the user-provided digital image; and
translating the identified image text to machine-encoded text using optical character recognition technology.

22. A computer program product comprising one or more computer storage media having stored thereon computer-executable instructions that, when executed at a processor, cause a computer system to perform a method for identify coating colors using a digital image, the method comprising:
receiving, through a network connection, a user-provided digital image of a vehicle;
accessing, within a vehicle template database, one or more vehicle templates;
mapping at least one conforming vehicle template to the vehicle within the user-provided digital image,
wherein the at least one conforming vehicle template comprises associated metadata comprising the one or more vehicle characteristics, including one or more associated color codes;
identifying, with an image processing module, a color value associated with the vehicle within the user-provided digital image;
calculating a closest match for identified color value associated with the vehicle from the one or more associated color codes;
providing a user the calculated closest match;
receiving user feedback that the calculated closest match is incorrect;
calculating a color shift profile; and
applying the color shift profile to user-provided digital images of vehicles comprising camera and lighting characteristics of the user-provided digital image of the vehicle.
